(19) United States
(12) Patent Application Publication
(10) Pub. No.: US 2007/0130008 A1
(43) Pub. Date: Jun. 7, 2007

(54) APPARATUS, SYSTEM, AND METHOD FOR LISTING AGGREGATION

(76) Inventors: Reed M. Brown, Fruit Heights, UT (US); Ronald W. Stagg, West Valley City, UT (US); Miles D. Romney, Los Angeles, CA (US)

Correspondence Address: David J. McKenzie, Suite 600, 8 East Broadway, Salt Lake City, UT, 84111, US

(21) Appl. No.: 11/549,750

(22) Filed: Oct. 16, 2006

Related U.S. Application Data
(60) Provisional application No. 60/726,719, filed on Oct. 14, 2005.

(51) Int. Cl. G07G 1/14

(52) U.S. Cl. 705/14

(57) ABSTRACT

An apparatus, system, and method are disclosed for listing aggregation. The present invention may include a selection module configured select one or more publishers from a plurality of independent publishers in response to user input. The independent publishers are registered to distribute and publish a listing for a user. The invention may also include an authorization module configured to accept authorization from the user to publish the listing with the selected publishers. Additionally, the invention may include a procurement module configured to arrange for the publication of the listing with the selected publishers by way of electronic communication. Advantageously, the invention reduces the difficulty of listing an advertisement with more than one publisher.

### CROSS-REFERENCES TO RELATED APPLICATIONS

This application claims benefit of U.S. Provisional Patent Application No. 60/726,719 entitled “Apparatus, System, and Method for Listing Aggregation” and filed on Oct. 14, 2005 for Reed M. Brown, et al., which is incorporated herein by reference.

### BACKGROUND OF THE INVENTION

1. Field of the Invention

This invention relates to advertising and more particularly relates to aggregation of advertisement listings.

2. Description of the Related Art

Individuals and organizations desire to place advertisements before target consumers so that those target consumers can consume the advertised goods and services. Publishers provide a venue for placing such advertisements in the form of classified ad sections, auctions, display ads, print advertisements, and online ad services. Advertisers contract with these publishers to place the advertisements.

The market for advertisements is broad and diverse, spanning many mediums and even more individual publishers. All of these publishers have processes and requirements for placing advertisements. Many publishers have differing fee structures for displaying advertisements, as well.

Advertisers wish to reach as broad a segment of their target audience as possible, and often wish to contract with multiple independent publishers to display the same advertisement. The multiplicity of requirements and fees between publishers, however, makes the placement of an advertisement with multiple publishers a difficult and tedious task.

From the foregoing discussion, it should be apparent that a need exists for an apparatus, system, and method that reduces the difficulty of listing advertisements with more than one publisher. Beneficially, such an apparatus, system, and method would reduce the work required to publish a listing with more than one publisher.

### SUMMARY OF THE INVENTION

The present invention has been developed in response to the present state of the art, and in particular, in response to the problems and needs in the art that have not yet been fully solved by currently available advertising methods. Accordingly, the present invention has been developed to provide an apparatus, system, and method for listing aggregation that overcome many or all of the above-discussed shortcomings in the art.

The apparatus to match a single user with a plurality of advertisement publishers is provided with a plurality of modules configured to functionally execute the necessary steps of matching a single user with a plurality of advertising publishers. These modules in the described embodiments include a selection module configured select one or more publishers from a plurality of independent publishers in response to user input, the independent publishers are registered to distribute and publish a listing for a user, an authorization module configured to accept authorization from the user to publish the listing with the selected publishers, and a procurement module configured to arrange for the publication of the listing with the selected publishers by way of electronic communication.

The apparatus, in one embodiment, includes a payment module configured to receive a payment from the user, the payment based at least in part on a publication fee charged by each selected publisher of the listing. In another embodiment, the payment module is configured to remit at least a portion of the payment to the publisher. In a further embodiment, the payment is discounted for a targeted customer.

The selection module, in one embodiment, filters the plurality of independent publishers available for selection based on filter criteria specified by the user. In another embodiment, the selection module presents the plurality of independent publishers available for selection based on filter criteria specified by an operator of the apparatus.

In a further embodiment, the apparatus includes a creation module configured to create a listing for publication in response to user input. The creation module may display a preview of the listing formatted according to the requirements of each selected publisher. In one embodiment, the creation module stores the listing in a searchable central store. Stored listing may be retrieved later for re-use by the same customers. In a further embodiment, the apparatus includes a customer tracking module configured to store customer data in a searchable central store. The stored customer data may be retrieved later to service subsequent user requests.

In another embodiment, the apparatus includes a verification module configured to communicate a listing to each selected publisher and request verification of acceptability of the listing from each selected publisher. The verification module may also communicate a rejection of the listing from the publisher to the user. In a further embodiment, the rejection may include a reason for rejecting the listing from the publisher. In one embodiment, the verification module receives publisher input that edits the listing. Editing the listing includes the content of the listing as well as associated parameters such as the listing category, start date, end date, or the like. In certain embodiments, the verification module returns the edited listing to the user for approval. Once approved the user may then pay to have the listing printed as agreed.

The procurement module, in one embodiment, may be further configured to generate a human-readable report to facilitate manual scheduling of the publication of the listing by a human. In another embodiment, the selection module may calculate a best fit publishing schedule between a publishing schedule for a selected publisher and a desired start date and end date provided by the user. The selection module may also compute a publishing count for the number of times the listing will be published in a selected publisher's media based on the publisher's publishing frequency and a desired start date and end date provided by the user.

A computer program product of the present invention is also presented for matching a single user with a variety of publishers. The computer program product may comprise a computer useable medium having a computer readable program. The program may be executed on a computer to implement the functions necessary to present a user with a plurality of independent publishers, to allow the user to select one or more publishers to publish a listing, to accept an authorization from the user to publish the listing with the selected publishers, to schedule the publication of the listing with the selected publishers, and to receive a payment from the user using electronic communication.

In one embodiment, the computer program product may cause the computer to present a user with an option to schedule the publication of the listing with a single button click. In another embodiment, the computer program product may cause the computer to schedule the publication of the listing with an online publisher.

A method of the present invention is also presented for matching a single user with a plurality of publishers. The method in the disclosed embodiments substantially includes the steps necessary to carry out the functions presented above with respect to the operation of the described apparatus and computer program product. In one embodiment, the method includes receiving a listing from a user, presenting a plurality of publishers for selection by the user, receiving a selection of publishers from the user, and placing the listing with the selected publishers.

In a further embodiment, presenting a plurality of publishers includes filtering the plurality of publishers to match criteria specified by the user. In another embodiment, the method includes receiving a payment from the user. The method may also include remitting a payment to the selected publishers.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating an environment in which the present invention operates;

FIG. 2 is a schematic block diagram illustrating one embodiment of a system for aggregating listings;

FIG. 3 is a sample web page from one embodiment of a user interface of a system for aggregating listings;

FIG. 4 is a sample web page from one embodiment of a user interface of a system for aggregating listings;

FIG. 5 is a sample web page from one embodiment of a user interface of a system for aggregating listings;

FIG. 6 is a sample web page from one embodiment of a user interface of a system for aggregating listings;

FIG. 7 is a sample web page from one embodiment of a user interface of a system for aggregating listings;

FIG. 7a is a sample web page from one embodiment of a user interface of a system for aggregating listings;

FIG. 8 is a sample web page from one embodiment of a user interface of a system for aggregating listings;

FIG. 9 is a sample web page from one embodiment of a user interface of a system for aggregating listings;

FIG. 10 is a sample web page from one embodiment of a user interface of a system for aggregating listings; and

FIG. 11 is a flow chart diagram illustrating one embodiment of a method for matching a single user with a plurality of publishers.

### DETAILED DESCRIPTION

The embodiment as illustrated is an electronically enabled, Internet accessible listing selection tool. Listings may be newspaper listings, Internet listings, blog entries, newsgroup postings, radio advertisements, television advertisements, Internet job postings, or other informational items.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Unless otherwise indicated, a module may comprise a commercially available computer program or specially designed computer software and hardware such as are known in the art. An example of an appropriate programming language includes “PHP” hypertext pre-processor, which could also be described as a “programming language” or a “scripting language” (Copyright 2011-2015 The PHP Group.)

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

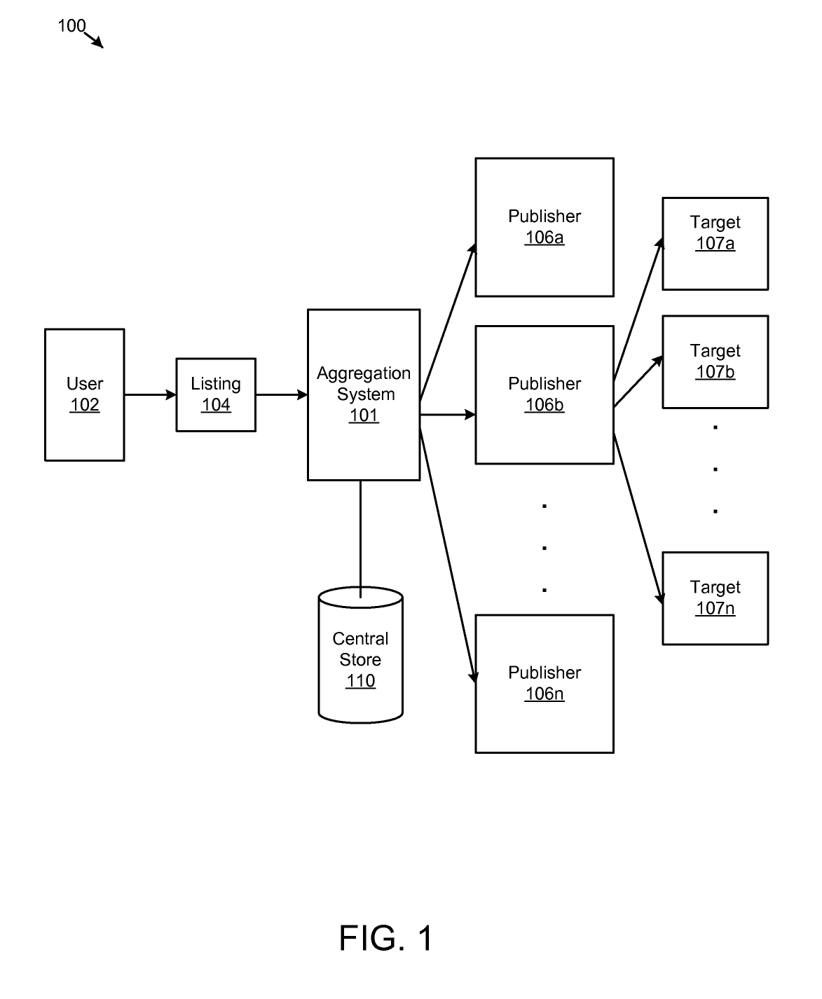

FIG. 1 is a schematic block diagram illustrating the environment 100 in which an aggregation system 101 of the present invention operates. The aggregation system 101 interacts with a user 102 and a plurality of independent publishers 106a-n. The aggregation system 101 assists the user 102 to publish a listing 104 with one or more publishers 106. Each publisher 106 delivers the listing 104 to a plurality of targets 107. The aggregation system 101 may interact with a central store 110 to store data. In FIG. 1, publisher 106b delivers the listing 104 to targets 107a-n. The aggregation system 101 acts as an interface between the user 102 and the publishers 106, shielding the user 102 from the formatting details and the billing details that each publisher may require. Additionally, the aggregation system 101 shields the publishers 106 from the need to interact personally with the user 102.

The user 102 may be an individual consumer, a business, a group of individuals, or other entity. Generally, the user 102 desires to notify targets 107 of an offer or event. The user 102 may be located in a specific locale and may prefer to deliver notifications to targets 107 located in specific geographic regions proximate to that locale of the user 102. Alternatively, the user 102 may desire to target categories of targets 107 or specific targets 107. In another embodiment, the user 102 may be an ad agency that desires to deliver advertisements to targets 107 on behalf of a third-party client. The aggregation system 101 in conjunction with the publishers 106 assists the user 102 in reaching a desired number of targets 107.

Targets 107 may be individuals, businesses, or groups of individuals. Targets 107 may be classified according to geographic location, interests, age groups, and social groups, as well as other classifications. The publishers 106 may provide target classifications to the aggregation system 101 that may be used to assist the user 102 in selecting potential publishers 106.

The listing 104 may be an advertisement, a job posting, a classified ad, an announcement, a personals match making listing, or other informational listing which the user 102 desires to deliver to the targets 107. As an example, a user 102 may wish to hire a nurse to fill a vacant position, sell a dog, announce that a cat has been found, sell an antique automobile, sell house painting services, sell stock tip information, or sell car repair services. The listing 104 embodies the advertisement or announcement which the user 104 desires to distribute to targets 107. The listing 104 may comprise a purely text listing, a graphical listing, a sound recording, a video recording, or a combination of text, graphics, sounds and video. The listing may also embody other media devices not listed here.

Publishers 106 provide media services for publishing the listing 104. Publishers 106 may include newspapers, periodical publishers, television stations, radio stations, web servers, internet service providers, web portals, and other media outlets used to display or deliver content to targets 107. Generally, the publishers 106 are independent organizations, companies, and/or individuals. Although the aggregation system 101 interacts with the publishers 106, the publishers 106 are typically independent from each other and from the aggregation system 101.

The central store 110, in one embodiment, stores data relating to the aggregation system. The central store 110 may comprise a database on a computer configured to receive data from the aggregation system. The data in the central store 110 may be searchable such that an operator of the aggregation system 101 may create ordered lists or filtered data relating to the aggregation system 101. In another embodiment, a publisher 106 may search the central store 110.

The data stored in the central store 110 may be any data relating to the aggregation system 101. Examples of data that may be stored in the central store 110 include user names, user locations, number of listings placed, number of publications of a single listing, payments made, and the like. In one embodiment, the central data store 110 may store a listing 104 created by a user 104. By storing data about users, transactions, and listings, the aggregation system 101 allows operators and publishers 106 to perform data mining activities to track trends relating to users and listings to improve the usability and profitability of the aggregation system 101. In a further embodiment, the central data store N 1110 may be searched for listings 104 previously created. The previously created listings 104 may then be retrieved for re-use for subsequent listings.

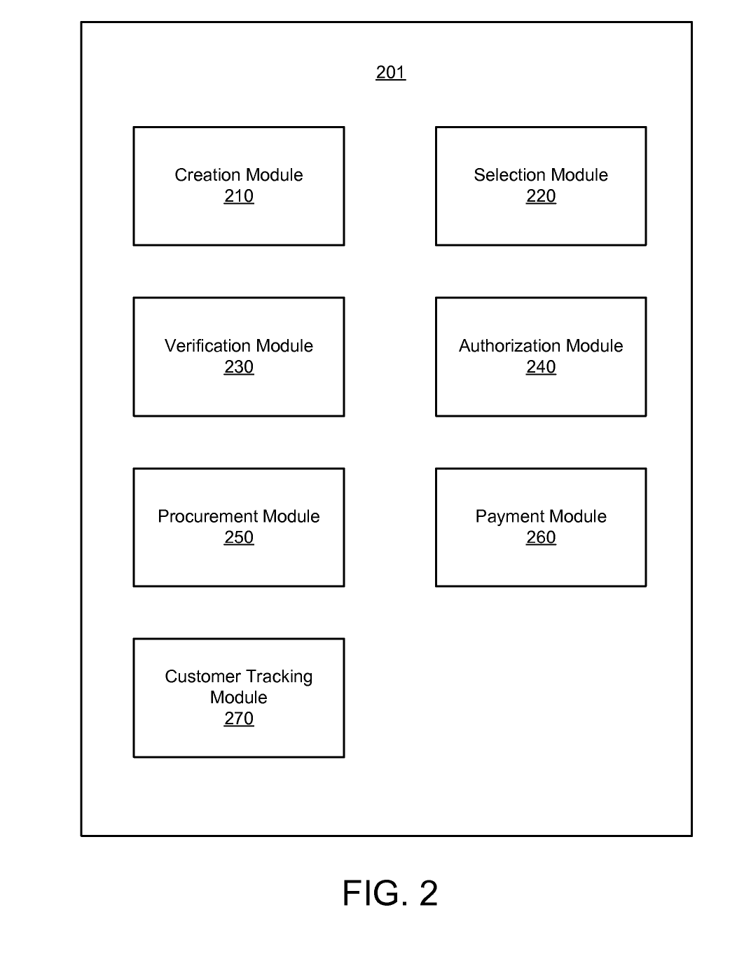

FIG. 2 is a schematic block diagram illustrating one embodiment of an aggregation system 201. Aggregation system 201 comprises a creation module 210, a selection module 220, a verification module 230, an authorization module 240, a procurement module 250, a payment module 260, and a customer tracking module 270. The aggregation system 201 allows a user 102 to place a single listing 104 in a plurality of media outlets to reach a high number of targets 107. For example, a user 102 who has a car to sell uses aggregation system 201 to create a classified listing, select a plurality of publishers 106, and publish the listing using the selected publishers 106. The aggregation system 201 makes the advertising process more efficient for users 102 and publishers 106, cutting transaction costs by aggregating information and reducing necessary steps to place a listing with a plurality of publishers 106.

The creation module 210 provides a user 102 with a mechanism to design and create a listing 104. In one embodiment, the creation module 210 provides a text editing tool to create a simple text classified listing 104. The aggregation system 201 may ultimately deliver the listing 104 to be published in a newspaper classified ads section, on a web page, on a web-based auction site, on a log, as an email to members of an email list, to an electronic billboard or marquee, to a community television channel, or the like. In an alternative embodiment, creation module 210 provides a mechanism to add multi-media content including graphics, sound, and/or video content. The user 102 may interact with the creation module 210 to design, build, construct, save, and revise the listing 104. Alternatively, the creation module 210 may accept a ready-built listing 104 or may build the listing 104 using a template. In certain embodiments, the creation module 210 stores the listing in a central store 110 for subsequent retrieval or reuse.

The creation module 210 may be configured to provide margins and size parameters to assist the user of the creation module 210 in designing an appropriate listing 104. The creation module 210 may pass the final margins and size parameters to the aggregation system 201 or to other modules in the aggregation system 201 as needed. The creation module 210 formats the listing 104 according to requirements of the selected publisher 106. For those instances where different formats may be required for different publishing media, the creation module 210 may be configured to format a single listing differently according to the media requirements of each publisher 106. In one embodiment, the creation module 210 displays a preview of the listing 104 formatted according to the requirements of each selected publisher 106. For example, when two publishers 106 with differing formatting requirements are selected, the creation module 210 may display two previews of the listing 104, one for each set of formatting requirements.

The selection module 220 provides a list of independent publishers 106 to the user 102. The list of publishers 106 may comprise newspapers, web sites, billboards, movie theaters, and other publishing entities capable of publishing the listing 104. The selection module 220 may present a filtered list of publishers 106 to the user 102 in accordance with the configuration of the aggregation system 201. Filtering may prioritize or favor publishers 106 which meet certain filtering criteria. In some instances, the user 102 configures filtering and sorting criteria. In other instances, the owner or operator of the aggregation system 201 configures filtering criteria.

Filtering may result in the presentation of a list of publishers 106 to the user 102 that represents a subset of the complete list of publishers 106 available through the aggregation system 201. In another embodiment, filtering may sort the complete list of publishers 106 available through the aggregation system 201 to order the list such that publishers 106 that better meet the specified filtering criteria are listed before other publishers 106. In yet another embodiment, filtering may result in the presentation of a subset of the complete list of publishers 106 that is also sorted in response to the filtering criteria.

Examples of filtering criteria may include the distance between the user 102 and potential targets 107, the publisher pricing, publisher media type, publisher sponsorship payments, the number of subscribers the publisher reaches, and other criteria. A user 102 may choose to advertise a thoroughbred horse with publishers 106 that cater to regions where thoroughbred horse breeding is popular. For example, one publisher selected may be a horse related periodical. Another user 102 may choose to advertise the sale of a car only in publications which cater to consumers located less than one hundred miles from the location of the car. In another example, publisher 106 may make a publisher sponsorship payment to the operator of the aggregation system 201 to receive a preferred placement in the list of filtered publishers provided to the user 102. Consequently, such publishers may be listed near the top of listings of publishers either in the complete list of publishers 106, the filtered list of publishers, and/or in combinations of both.

The selection module 220 displays the sorted and/or or filtered publishers 106 and allows the user 102 to select one or more publishers 106. The selection module 220 may display pricing information for each publisher 106 and may calculate pricing specific to the listing 104 designed using the creation module 210. Prices may be determined based on criteria provided by each publisher 106. The user 102 may select specific publishers 106 for the listing 104 as well as dates and times for publication. In this manner, the selection module 220 allows the user 102 to select a plurality of publishers 106 to publish the single listing 104.

Once the user 102 designs or creates a listing 104 using the creation module 210 and selects publishers 106 to publish the listing 104 using the selection module 220, the verification module 230 may query the selected publishers 106 and request verification of acceptability of the chosen listing 104. For example, the verification module 230 may allow a publisher 106 to verify that space is available to publish the listing 104 on the requested date. In another example a publisher 106 may respond to the verification module 230 with a rejection of the listing 104 based on the content of the listing 104 being unacceptable to the publisher 106.

Although the selection module 220 may display publisher-specific pricing, formatting, and scheduling information, the verification module 230 may query the selected publishers 106 to confirm pricing, availability, formatting restrictions, and other criteria. The verification module 230 may discover final pricing and formatting information for selected publishers.

The verification module 230 may also submit the proposed listing 104 to a selected publisher 106 for editorial review using an interface, such as a web interface, provided by the aggregation system 201. In one embodiment, the verification module 230 submits the listing 104 using an email message. In another embodiment, the verification module 230 sends a notification email which includes a link to a web page that serves as an interface for the publisher 106. The selected publisher 106 may reject the listing 104 due to unacceptable wording, unacceptable length, unacceptable media type requests, or other criteria. In one embodiment, the verification module 230 receives publisher input that edits the listing. Editing the listing may include editing the content of the listing as well as associated parameters such as the listing category, start date, end date, or the like. In certain embodiments, the verification module returns the edited listing to the user for approval. Once approved the user may then pay to have the edited listing printed as agreed.

The aggregation system 201 may contact publishers 106 using any of various electronic communications technologies including email, hypertext transport protocol (HTTP), simple object access protocol (SOAP), TCP/IP, fax, or other means. The aggregation system 201 presents a simple interface to the user 102 while hiding the complex communications requirements to query each selected publisher 106.

The authorization module 240 accepts authorization from the user 102 to publish the listing 104 in the selected publications 106. The authorization from the user may take the form of any commercially acceptable authorization. For example, the authorization may be a click of a button, or any other indication of assent. The authorization module 240 may also accept an authorization from the user 102 to charge the user 102 a fee. In one embodiment, the authorization module 240 may present a final contract to the user 102. The final contract may include the listing 104 as well as the schedule for the publication of the listing in the selected media. The final pricing and availability of each media may be aggregated into a single price or the authorization module 240 may display individual pricing broken out for each selected publisher 106. The authorization module 240 may also show a preview of the listing 104 for each publication. The authorization module 240 preferably is configured to provide a secure connection over which the user 102 may confidently indicate intent to authorize the publication of the listing.

The authorization module 240 may accept a signature from the user indicating the assent of the user to be bound by the final contract. The signature may comprise any commercially acceptable indication of assent, including electronic signing methods. For example, the user may sign the contract by clicking a button labeled “accept contract.”

The procurement module 250 is configured to place individual publication orders with each selected publisher 106. The procurement module 250 may be integrated with the authorization module 240 or may be a separate module. The procurement module 250 schedules the actual listing dates and the listing content with each publisher. In one embodiment, the procurement module 250 uses electronic communication to schedule the listings with individual publishers 106. Examples of electronic communication include email, hypertext transport protocol (HTTP), simple object access protocol (SOAP), TCP/IP, fax, and the like. In particular, the procurement module 250 is configured to interface with the systems or software of each selected publisher 106 in order to provide the listing and schedule its publication.

The procurement module 250 may use existing public web interfaces to contact each publisher 106. As an example, some newspaper classified departments currently allow the placement of listings 104 using an online web interface. The procurement module 250 may programmatically place the final orders through such web interfaces. The procurement module 250 may use a SOAP interface or a private interface made available by the publisher 106 to the operator of the aggregation system 201. Alternatively, the procurement module 250 may simply initiate the purchasing of advertising or may deliver the listing content to each publisher 106. For example, the procurement module 250 may create a report comprising the listing content along with selected publishers 106 and publishing dates and may provide the report to a human to physically place the listing 104. Alternatively, the procurement module 250 may create a report specific to a selected publisher 106 comprising a plurality of listings from different users and publishing dates for each listing. A person at the selected publisher 106 may use the report to manually place the listing 104. It should be understood that some of the modules of the aggregation system 201 may be partially or completely implemented by computing devices while some of the modules of the aggregation system 201 may be partially or completely implemented by humans.

The payment module 260 bills users 102 for contracted listings 104, receives payments from users 102, and pays publishers 106 for publishing contracted listings 104. In one embodiment, the payment module 260 provides a centralized location through which all billing is transacted. The payment module 260 preferably handles billing automatically or programmatically using for example an on-line payment system such as Paypal®. However, alternatively, the payment module 260 may trigger actions by humans to send or receive bills, invoices, and payments.

For example, in one embodiment, the payment module 260 requires an online credit card payment by a user 102 prior to placing the listing 104 with the selected publishers 106. Alternatively, the payment module 260 may print and mail an invoice to a user 102 following confirmation of listing selection and placement.

In one embodiment, the payment received from the user 102 may be based at least in part on a publication fee charged by each publisher 106. In another embodiment, the payment may comprise an aggregation fee charged by the operator of the aggregation system. The aggregation fee may be a flat per listing rate, a flat per publication rate, a percentage of publication fees, or any combination of these fees.

In a further embodiment, the payment may be discounted for targeted customers. For example, an operator of the aggregation system 201 may provide targeted potential customers with a coupon code that, when entered into the payment module 260, discounts the required payment. In another example, the payment module 260 may reduce the payment required by the user 102 based on demographic data of the user that meets a desired profile.

In one embodiment, the payment module 260 receives invoice information from publishers 106 through a web interface or through a web service interface using a SOAP messaging scheme. The payment module 260 may also remit payments to the publishers 106 through an online SOAP message to the individual publishers 106 or to the bank of the aggregation system 201 operator. In another embodiment, payments may be transferred by the payment module 260 to a publisher 106 through an automated clearinghouse (ACH) transfer or an electronic funds transfer (EFT).

The customer tracking module 270, in one embodiment, accesses data stored in the central store 110 relating to users 102. The customer tracking module 270 may be configured to allow an operator of the aggregation system 201 to search for customers matching a certain demographic. The customer tracking module 270 may also be configured to allow an operator of the aggregation system 201 to determine trends relating to the users 102 of the aggregation system 201. Alternatively, publishers 106 may access the central store 110 to retrieve relevant customer data. For example, publishers 106 may mine the central store 110 in conjunction with offering certain targeted promotions. In addition, the aggregation system 201 may access the central store 110 and retrieve a previous listing(s) to facilitate use of the system 201 by repeat customers.

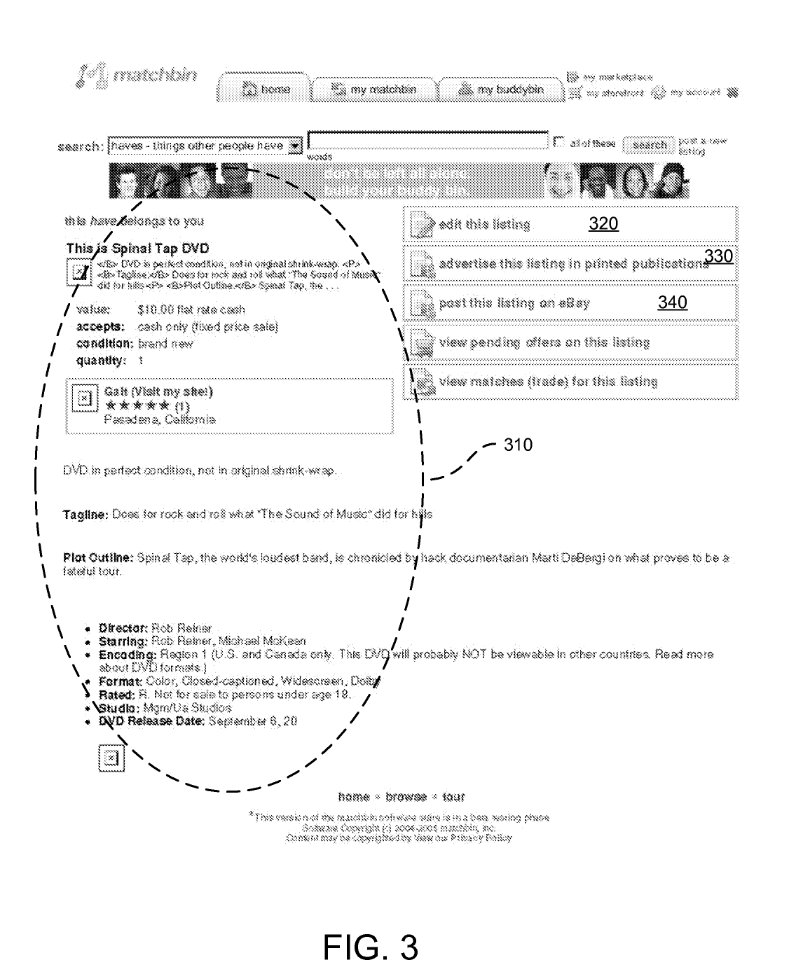

FIGS. 3, 4, and 5 depict three sample web pages of various embodiments of user interfaces to partially implement the creation module 210, the selection module 220, and the payment module 260.

FIG. 3 depicts a web page 300 which displays a listing 310 for a Spinal Tap DVD. The listing 310 as shown contains HTML (hyper text markup language) formatting tags. The listing 104 may be a listing 104 created by the selection module 210. Alternatively, the listing 104 may be an existing listing 104 taken from an online classified advertisement, from a newspaper advertisement, from an email, from a blog posting, from a newsgroup posting, or from some other preexisting source.

The web page of FIG. 3 further comprises selection 320, selection 330, and selection 340. The selections 320, 330, 340 may comprise buttons, icons, or hyperlinks. The selection 320 allows a user to access the creation module 210 to edit the listing 310. The selection 330 allows the user 102 to activate the selection module 220 using the current listing 104. The selection 340 allows the user to post the listing 104 on an online publisher such as eBay™, craigslist, or the like. Posting the listing 310 on eBay™ may create an eBay listing 310 with a single button click. Alternatively, selection 340 may cause additional dialogs to appear which the user 102 must complete in order to cause the aggregation system 101 to create an online publisher listing 310.

By choosing selection 330, the user 102 activates the selection module 220. The selection module 220 may copy fields from an existing listing 310. For instance, the Spinal Tap DVD listing 310 comprises advertisement text, an offer price, an offeror's name/ID and other information. All of this information may be copied by the aggregation system 201 to be used by the various modules in the aggregation system 201. For example, the advertisement text may be copied and used by the creation module 210 in designing a listing 310. Alternatively, the selection module 220 may automatically complete some fields used by the selection module 220 with information from the listing 310. Similarly, the authorization module 240, the payment module 260, or other modules may use information from the listing 310 in completing their respective duties.

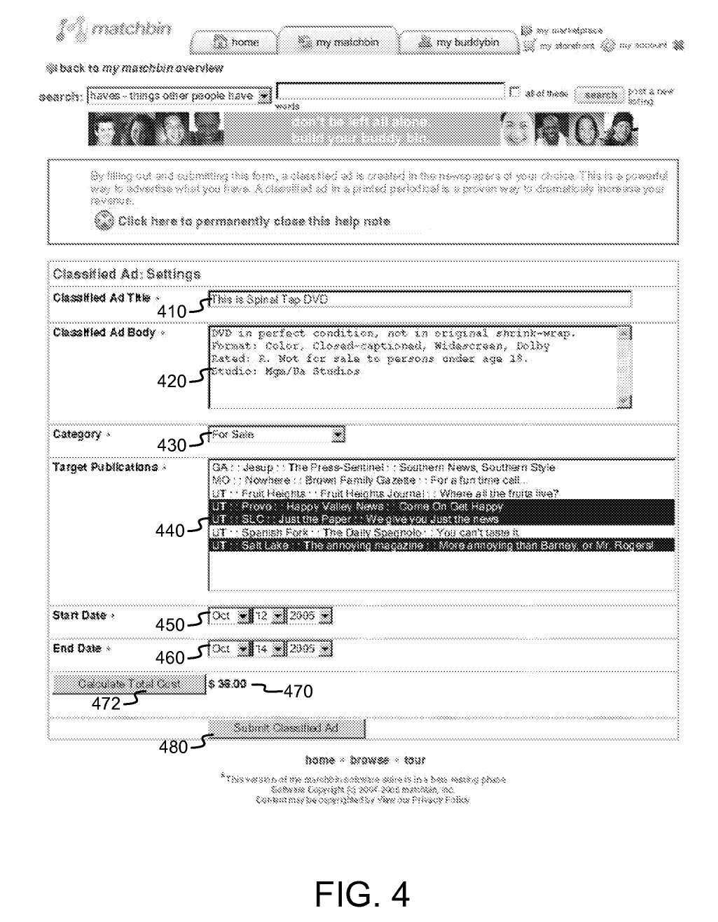

FIG. 4 illustrates an example of a web page that a user 102 may use to interact with the selection module 220. The web page comprises various fields including a listing title 410, a listing body 420, a listing category 430, a publisher selection 440, a listing start date 450, a listing end date 460, a listing calculated price 470, and a submit button 480.

The listing title 410 displays the title of the listing 104. The listing body 420 displays the text of the listing 104. It should be understood that FIG. 4 offers an example of an interface for viewing or editing a listing 104. In the example, the listing body 420 does not include sound and video options. However, other sound and video options could also be included by those of skill in the art.

The listing category 430 provides a listing 104 category. In this example, the listing category 430 may be set to “For Sale,” “Wanted,” “Trade,” “Help Wanted,” or “Announcement.” Listings 104 could also be categorized by geographic location, by merchandise type, or by other category schemes. Preferably, the listing category comes from existing categories defined by the different publishers 106.

The publisher selection 440 lists the various publishers 106 in which the listing 104 may be published. In the example, the publishers 106 are listed by geographic region. They publishers 106 may also be listed according to the types of targets 107 that the publisher 106 serves.

The listing start date 450 specifies the first date that the listing 104 will be published. The listing end date 460 specifies the last date that the listing 104 will be published. The listing calculated price 470 displays the calculated price of the listing. The listing calculated price 470 typically aggregates the price calculated for publishing the listing 104 with each selected publisher 106. Preferably, a user 102 can repeatedly change the listing body 420, listing category 430, publisher selection 440, start date 450, and end date 460, in order to increase or decrease the calculated price. Activating the calculate button 472 may cause the payment module 260 to compute a new cost based on revisions a user 103 has made. Alternatively, the web page 104 may be configured such that changes to the listing body 420 automatically cause the calculated price to be updated to reflect the change. The web page 104 may also optionally reflect a discount for choosing multiple publishers 106 as well as other discounts. Finally, the submit button 480 allows the user 102 to accept the drafted listing 104 and the selected publishers 106.

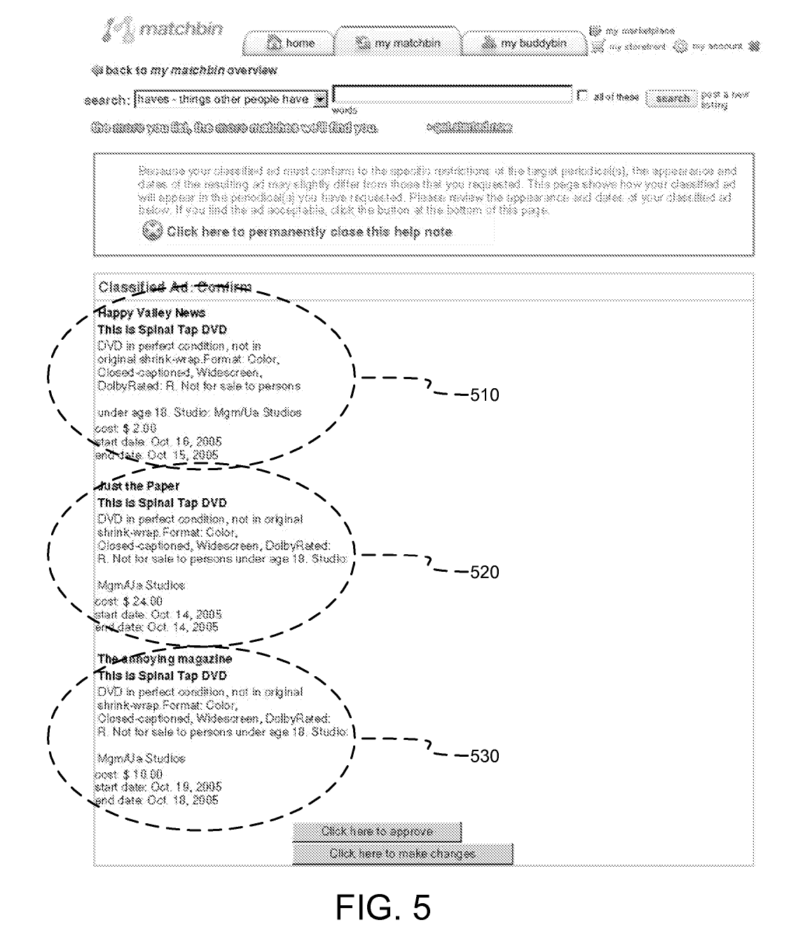

FIG. 5 illustrates an example of a final approval web page. The final approval web page comprises a final listing 510, a final listing 520, a final listing 530, a approval button 540, and a make changes button 550.

The final listing 510 displays the name of the publisher 106 as well as the price and the scheduled run dates of the final listing 510. Similar information is shown for final listing 520 and final listing 530. Each final listing 510, 520, 530 is displayed in accordance with the length, width, and other formatting requirements of the respective publisher 106.

In addition, the selection module 220 determines the start date and end date for publishing the listing with each publisher 106. Preferably, the selection module 220 calculates a best fit publishing schedule between the publishing schedule for each publisher 106 and the desired start date 450 and end date 460 indicated by the user 102. For example, a start date 450 of Oct. 5, 2005 and end date 460 of Oct. 10, 2005 may result in a start date and end date in the final listing 510, 520, 530 of October 2005 for a publisher that only publishes monthly.

In one embodiment, the selection module 220 may also compute a count for the number of times the listing 104 will be published in each publisher's media based on each publisher's publishing frequency. This count may be included in the final listings 510, 520, 530. The user 102 may verify that the correct publishers 106 have been chosen and that all other selections related to the listing 104 are correct. The user 102 may accept or modify the listing selections using the approval button 540 and the make changes button 550.

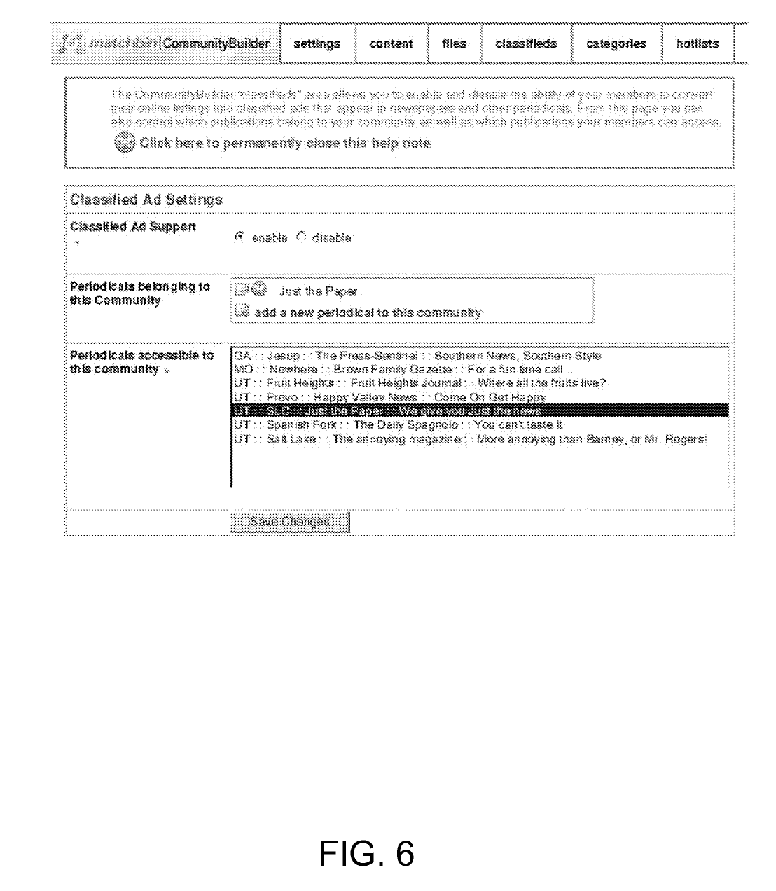

FIG. 6 provides an interface for an aggregation system 101 operator to specify specific publishers 106 that a community of users 102 may access. In other words, the operator may create groups or communities of users 102. Users 102 in one group may be permitted only to access specific publishers 106. In the example, the operator has enabled only access to a publisher 106 entitled “Just the Paper.” From this interface, an operator may add new publishers or include predefined publishers 106.

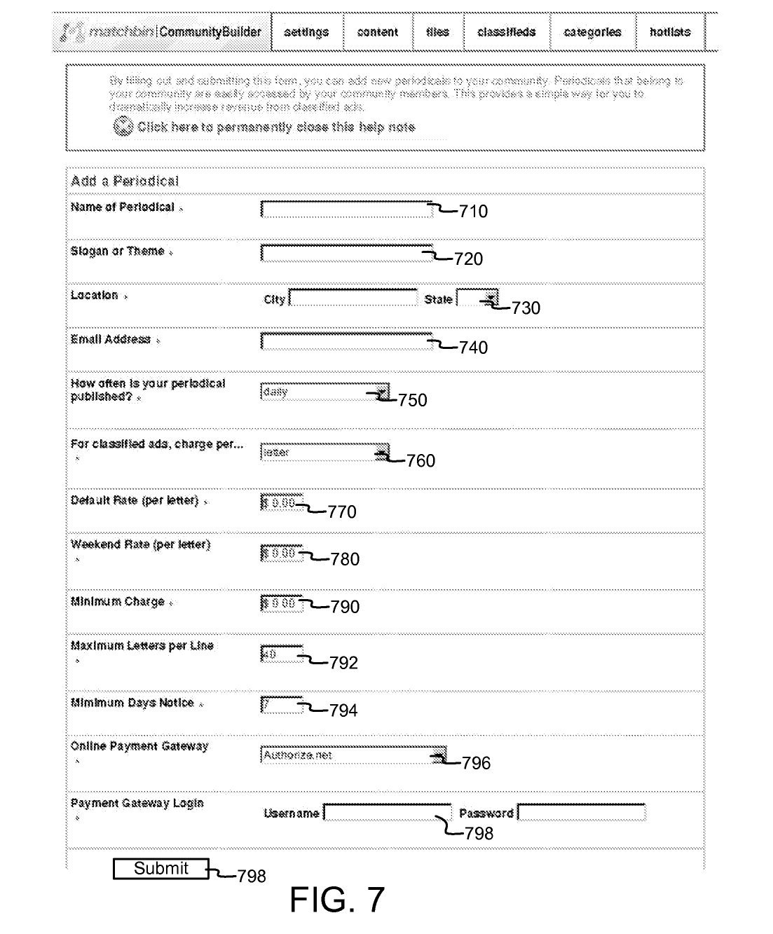

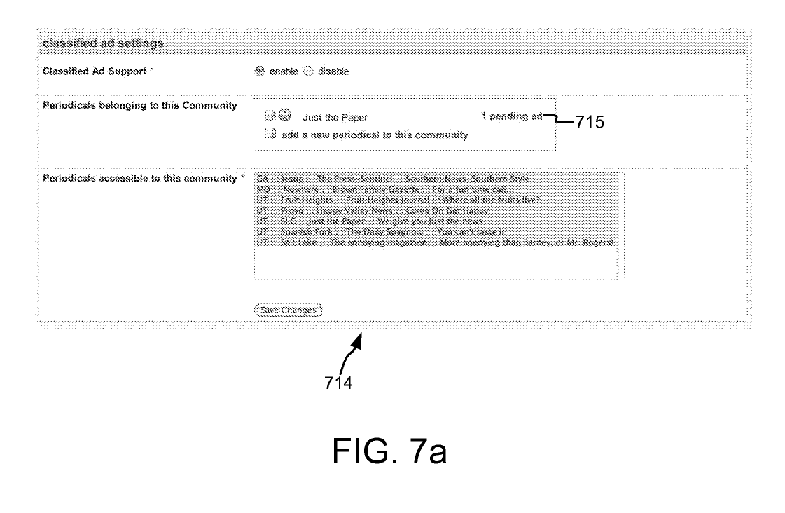

FIG. 7 illustrates an example interface for an aggregation system operator to add publishers 106 to the aggregation system 101. Operators of the aggregation system 101 or publishers 106 themselves may add publishers 106 to the aggregation system 101. The example interface comprises the following fields: a periodical name 710, a publisher slogan 720, a publisher location 730, a publisher email address 740, a publication frequency 750, a charge unit 760, a daily rate 770, a weekend rate 780, a minimum charge 790, a maximum letters per line 792, a minimum days notice 794, an online payment gateway 796, online gateway security information 798, and a submit button 799.

The periodical name 710 specifies the publisher 106 name. The publisher slogan 720 specifies the slogan of the publisher 106. The publisher location 730 specifies the city and state where the publisher 106 is located or the community that the publisher 106 serves, whichever is more pertinent. The publisher email address 740 specifies an email address at which the publisher 106 may be contacted or at which a publisher 106 desires to receive finalized listings 104.

The publication frequency 750 specifies how often the publisher 106 distributes new copies of their publication. For example, some publishers 106 publish daily while others publish weekly. Some publishers 106 publish Tuesdays and Fridays. The publication frequency 750 field collects this type of information. The publication frequency 750 may be used by various modules in the aggregation system 201 in determining pricing, payments and so forth.

The charge unit 760 defines the unit of measurement used for calculating fees by the publisher 106. For instance, some newspapers charge per character while others charge per line. Some web sites charge based on visits and do not charge based on content size. The charge unit 760 is used by the aggregation system 201 in conjunction with the daily rate 770, the weekend rate 780, the minimum charge 790, and the maximum letters per line 792 to determine a price for a listing 104.

The minimum days notice 794 specifies the advance notice that a user 102 must give prior to placing a listing 104. The online payment gateway 796 specifies a gateway or website which the aggregation system 201 may use to make payments to the publisher 106. Note that in one embodiment, the aggregation system 201 makes payments to the publishers 106 while the user 102 makes payments to the aggregation system 201. The online gateway security information 798 may specify a username and password for making payments to the listed publisher 106. Of course, other payment arrangements may be made. Finally, the operator of the aggregation system 201 uses the submit button 799 to submit the information associated with a new publisher 106.

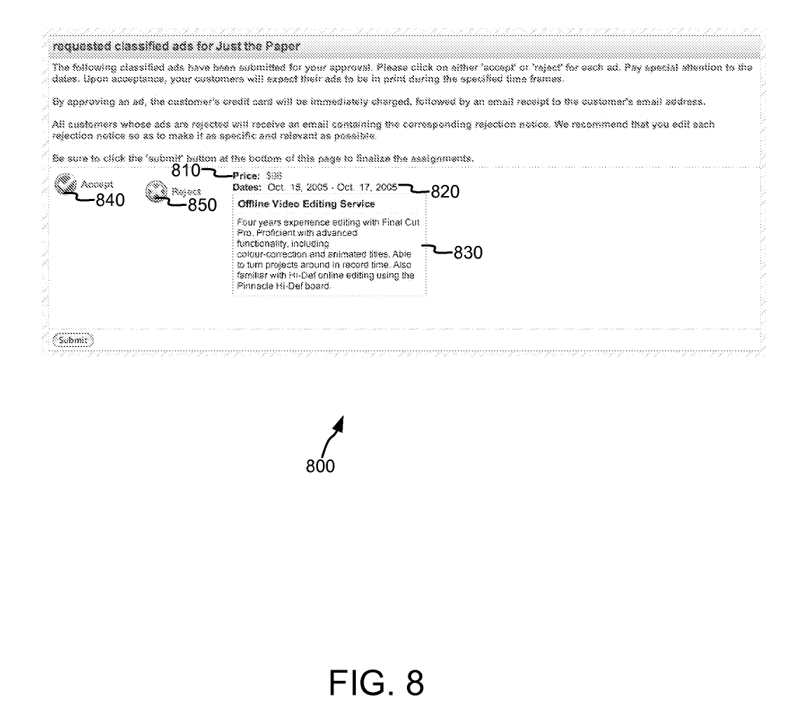

FIG. 7a illustrates a web page 714. The web page 714 is an example interface for a publisher 106 to use in conjunction with the verification module 230. In one embodiment of the aggregation system 101, the aggregation system 101 notifies a publisher 106 of proposed listings 104 that need approval. The web page 714 comprises a hyperlink 715 which a publisher 106 may select to review pending listings 104. By selecting hyperlink 715, the publisher 106 will view web page 800 of FIG. 8.

FIG. 8 illustrates a web page 800. The web page 800 is an example interface for a publisher 106 to use in accepting or rejecting a proposed listing 104 in accordance with processing of the verification module 230. Under one embodiment of the aggregation system 101, a user 102 creates or provides a listing 104 and selects publishers 106 to publish the listing 104. The user 102 further selects publication dates. However, the publishers 106 may have editorial control over the final acceptance of a listing 104. A publisher 106 may reject a listing 104 due to space limitations, inappropriate language, formatting constraints, price miscalculations, time constraints or for other reasons.

The verification module 230 provides a proposed listing 104 to each selected publisher 106 for final approval. The verification module 230 collects favorable or unfavorable responses from each selected publisher 106 with regards to proposed listings 104. In one embodiment of the aggregation system 101, the verification module 230 allows the publishers 106 to exercise complete editorial control over proposed listings 104.

The example web page 800 comprises a publisher price 810, listing dates 820, a listing text 830, an accept button 840, and a reject button 850. The publisher price 810 reflects the money that the publisher 106 will receive for publishing the proposed listing 104. The listing dates 820 indicate the dates that the publisher 106 will publish the listing 104. The listing text 830 displays the actual text to be published. The example in FIG. 8 illustrates a text-only listing 104. However, the listing 104 could contain graphics, sound, and video components as well.

The accept button 840 and the reject button 850 provide the publisher 106 with the options of accepting or rejecting the proposed listing 104. By selecting the accept button 840, the publisher 106 contracts with the operator of the aggregation system 101 to publish the proposed listing 104 as displayed in the web page 800. In rejecting the listing 104 using the reject button 850, the publisher 106 may communicate to the aggregation system 101 and ultimately to the user 102 the reasons for the rejection.

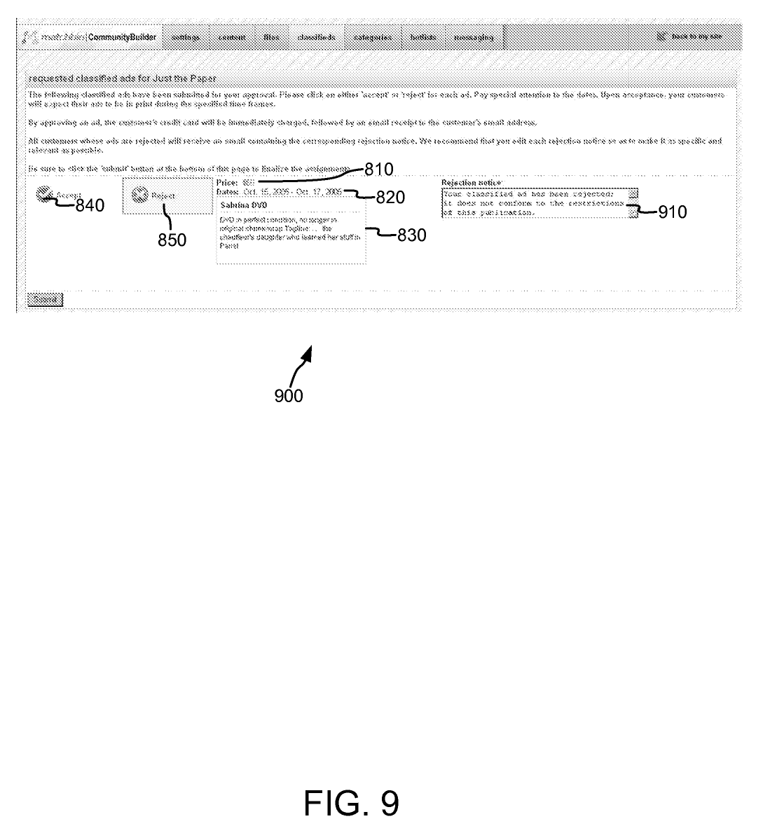

FIG. 9 illustrates a web page 900 similar to the web page 800. The web page 900 further comprises a text box 910 for a publisher 106 to enter a rejection reason. The publisher 106 may provide detailed reasoning to instruct the user 102 how to modify the listing 104 to make the listing 104 acceptable.

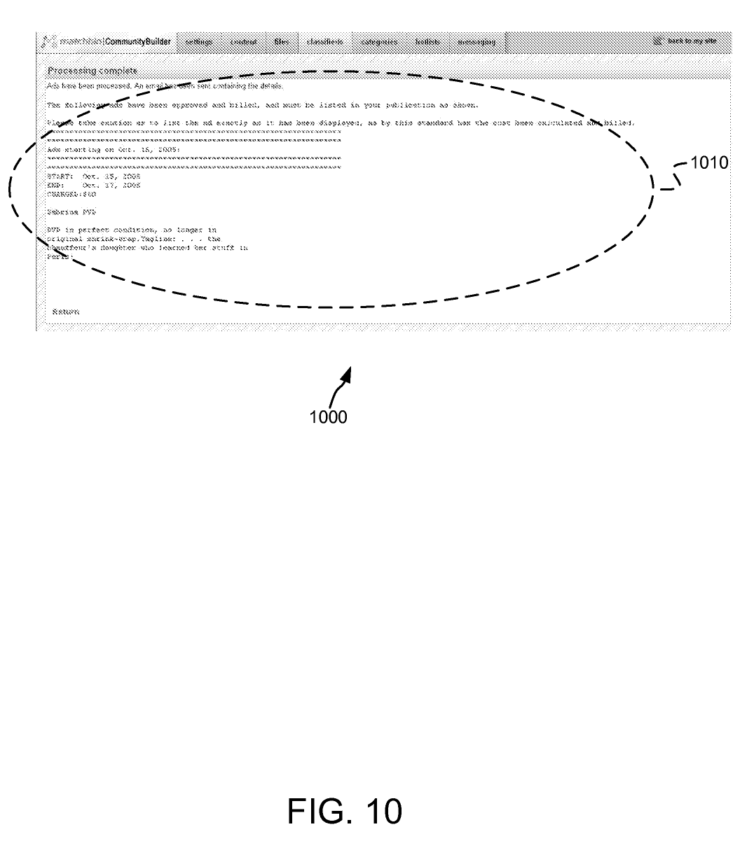

FIG. 10 illustrates one embodiment of a confirmation web page 1000. After a publisher 106 accepts a listing 104, the aggregation system 101 confirms the acceptance of the listing 104. Web page 1000 comprises a confirmation message 1010. Confirmation message 1010 comprises instructions to the publisher 106 concerning a recently accepted listing 104. Confirmation message 1010 lists the publisher price 810, the listing dates 820, and the listing text 830 and confirms that the publisher 106 must now publish the listing 104.

FIGS. 3-10 serve as examples of various interfaces which users 102, publishers 106 and operators use to interact with the aggregation system 101. Those of skill in the art will understand that other interfaces, including non-web-based interfaces, may also be used to interface with the aggregation system 101 without departing from the spirit of the invention.

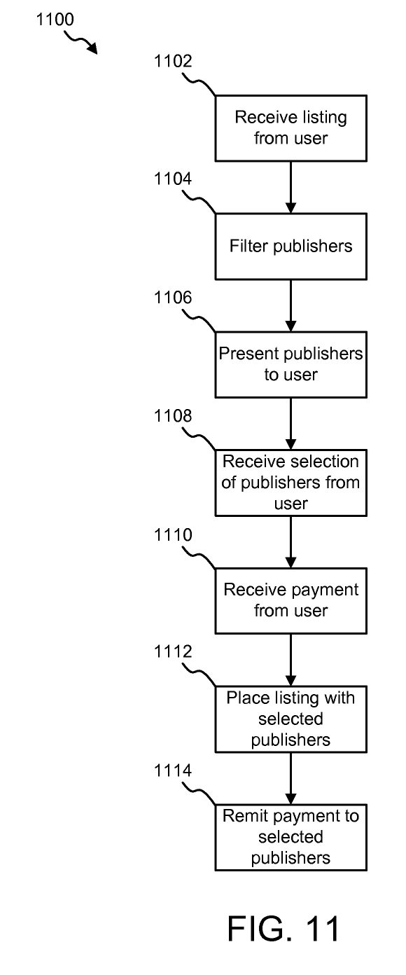

FIG. 11 is a flow chart diagram illustrating the various steps of a method 1100 for matching a user with a plurality of publishers. The method 1100 is in certain embodiments a method of use of the system and apparatus of FIGS. 1-10 and will be discussed in reference to those figures. Nevertheless, the method 1100 may also be conducted independently thereof and is not intended to be limited specifically to the specific embodiments discussed above with respect to those figures.

As shown in FIG. 11, the method 1100 first receives 1102 a listing 104 from a user 102. The listing 104 may comprise an item for sale, a help wanted ad, an announcement, or any other information the user 102 may wish to transmit to one or more targets 107.

Next, the method 1100 filters 1104 a list of independent publishers 106 for display to the user 102. The list of publishers 106 may be filtered 1104 by filtering criteria defined by the user 102, by filtering criteria defined by the operator of an aggregation system, or by a combination of the two. The filtering criteria used to filter 1104 the list of publishers 106 may include geographic information, demographic information, category information, preferred listing payments, or the like. Filtering 1104 may comprise selecting a subset of the complete lists of publishers 106, may comprise sorting the complete list of publishers 106, or may comprise sorting a subset of the complete list of publishers 106.

The method 1100 then presents 1106 the filtered list of publishers 106 to the user 102. The list of publishers 106 may include options for additional filtering by the user 102.

Next, the method 1100 receives 1108 a selection of publishers 106 from the user 102. The selected publishers 106 are the publishers 106 the user 102 wishes to display the listing 104.

The method 1100 then receives 1110 a payment from the user 102. The payment may be received 1110 via electronic communication. For example, the method 1100 may coordinate and arrange to receive a payment through a PayPal® account from the user 102. The payment may be based at least in part on a publication fee charged by each selected publisher of the listing.

Next, the method 1100 places 1112 the listing 104 with the selected publishers 106. In one embodiment, the listing 104 may be placed 1112 using electronic communication with the selected publishers 106. In one embodiment, the listing 104 is placed 1112 with the publisher through an interface with the systems or software of the selected publisher 106 in order to provide the listing and schedule its publication. The listing 104 may be placed 1112 using a SOAP interface or a private interface made available by the publisher 106 to the operator of the aggregation system 201. Alternatively, the listing 104 may be placed 1112 simply by initiating the purchasing of advertising or by delivering the listing content to each publisher 106.

Then, the method 1100 remits 1114 a payment to the selected publishers 106. In one embodiment, the payment remitted to the selected publishers comprises at least a portion of the payment received 1110 from the user 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to match a single user with a plurality of advertisement: publishers, the apparatus comprising
a selection module configured select one or more publishers from a plurality of independent publishers in response to user input, the independent publishers registered to distribute and publish a listing for a user;
an authorization module configured to accept authorization from the user to publish the listing with the selected publishers; and
a procurement module configured to arrange for the publication of the listing with the selected publishers by way of electronic communication.

2. The apparatus of claim 1, further comprising a payment module configured to receive a payment from the user, the payment based at least in part on a publication fee charged by each selected publisher of the listing.

3. The apparatus of claim 2, wherein the payment module is configured to remit at least a portion of the payment to the publisher.

4. The apparatus of claim 2 wherein the payment is discounted for a targeted customer.

5. The apparatus of claim 1, wherein the selection module filters the plurality of independent publishers available for selection based on filter criteria specified by the user.

6. The apparatus of claim 1, wherein the selection module presents the plurality of independent publishers available for selection based on filter criteria specified by an operator of the apparatus.

7. The apparatus of claim 1, further comprising a creation module configured to create a listing for publication in response to user input.

8. The apparatus of claim 7, wherein the creation module displays a preview of the listing formatted according to the requirements of each selected publisher.

9. The apparatus of claim 7, wherein the creation module stores the listing in a searchable central store.

10. The apparatus of claim 1, further comprising a customer tracking module configured to store customer data in a searchable central store.

11. The apparatus of claim 1, further comprising a verification module configured to communicate a listing to each selected publisher and request verification of acceptability of the listing from each selected publisher.

12. The apparatus of claim 11 wherein the verification module is further configured to communicate a rejection of the listing from the publisher to the user.

13. The apparatus of claim 12 wherein the rejection includes a reason for rejecting the listing from the publisher.

14. The apparatus of claim 11 wherein the verification module is further configured to edit the listing in response to publisher input and return the edited listing to the user for approval.

15. The apparatus of claim 1, wherein the procurement module is further configured to generate a human-readable report to facilitate manual scheduling of the publication of the listing by a human.

16. The apparatus of claim 1, wherein the selection module is further configured to calculate a best fit publishing schedule between a publishing schedule for a selected publisher and a desired start date and end date provided by the user.

17. The apparatus of claim 1, wherein the selection module is further configured to compute a publishing count for the number of times the listing will be published in a selected publisher's media based on the publisher's publishing frequency and a desired start date and end date provided by the user.

18. A computer program product for matching a single user with a plurality of publishers, the computer program product comprising a computer useable medium having a computer readable program, wherein the computer readable program when executed on a computer causes the computer to:
present a user with a plurality of independent publishers to allow the user to select one or more publishers to publish a listing;
accept authorization from the user to publish the listing with the selected publishers;
schedule the publication of the listing with the selected publishers; and
receive a payment from the user using electronic communication.

19. The computer program product of claim 18, wherein the computer readable program when executed on a computer causes the computer to present a user with an option to schedule the publication of the listing with a single button click.

20. The computer program product of claim 18, wherein the computer readable program when executed on a computer causes the computer to schedule the publication of the listing with an online publisher.

21. A method for matching a single user with a plurality of publishers, the method comprising:
receiving a listing from a user;
presenting a plurality of publishers for selection by the user;
receiving a selection of publishers from the user; and
placing the listing with the selected publishers.

22. The method of claim 21, wherein presenting a plurality of publishers further comprises filtering the plurality of publishers to match criteria specified by the user.

23. The method of claim 21, further comprising receiving a payment from the user.

24. The method of claim 21, further comprising remitting a payment to the selected publishers.
